(19) United States
(12) Patent Application Publication
(10) Pub. No.: US 2003/0230083 A1
(43) Pub. Date: Dec. 18, 2003

(54) Continuously variable torque shredder drive

(76) Inventor: John Dorscht, Kitchener (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/170,430

(22) Filed: Jun. 14, 2002

(51) Int. Cl. F16D 31/02

(52) U.S. Cl. 60/443; 60/493

(57) ABSTRACT

A hydraulic drive system has a variable displacement hydraulic pump; a prime mover driving the hydraulic pump; a variable displacement hydraulic motor fed hydraulic fluid by the hydraulic pump, the hydraulic motor having internal torque control and speed modulation via the variable displacement; and a shaft driven by the hydraulic motor. The prime mover is either an electric motor or an internal combustion engine, advantageously a diesel engine. The system is either an open loop hydraulic system or a closed loop hydraulic system. With the system, relatively low output prime movers are used without reduction in the systems maximum torque output.

### BACKGROUND OF THE INVENTION

This invention relates to a hydraulic drive system for providing rotation to a shaft, particularly for single or multiple shaft shredders, grinders and other comminution equipment.

### SUMMARY OF THE INVENTION

It is an object of the invention to provide an integrated drive system which is more economical to purchase and operate than known systems but which will provide the necessary output on an “as needed” basis only. This will lower the required power output of the prime mover used and also lower the structure and requirements on equipment to connect the prime mover to the hydraulic system.

In the invention, a prime mover provides input power to a hydraulic drive system comprising a variable displacement hydraulic pump; a directional hydraulic valve; a variable displacement hydraulic motor fed hydraulic fluid by the hydraulic pump, the hydraulic motor having internal torque control and speed modulation through a valve via the variable displacement; and a shaft driven by the hydraulic motor. The shaft is, for instance, a shredder shaft, a grinder shaft or a rotating shaft of other comminuting equipment.

The prime mover is either an electric motor or an internal combustion engine, advantageously a diesel engine.

The hydraulic pump provides constant and maximum horsepower control by torque control, modulating the pressure and volume output to reduce pump flow output as a function of pressure as maximum input horsepower is reached. To this end, the system has a system operating pressure sensor which sends a signal to a torque control valve spool means of the hydraulic pump to adjust a hydraulic pump swash plate for varying an output flow of the hydraulic pump to thereby provide the torque control.

The system is either an open loop hydraulic system or a closed loop hydraulic system.

Torque and horsepower control allow the use of small engines and electric motors to produce a final output at the shredder shaft selectively high speed with low torque or low speed with high torque, all variable without steps.

A particular advantage of the invention is that shaft speed and cutter tip force (torque) are a function of the feedstock material being processed, therefore optimizing processing production rates (see FIGS. 3 to 5). When encountering materials which are tough to process, the motor displacement continuously increases, effectively increasing torque and cutter tip force to break through materials. When encountering non-processable materials, the cutter tip stalls, the system produces a maximum preset operating pressure, holds that pressure for a certain time period (for example one second) as sensed by a pressure switch and programmable logic controller (PLC), which then reverses rotation direction of the shredder shaft by energizing a valve, to repeat the operation but in the opposite direction (see FIGS. 1 and 2). This arrangement allows the use of relatively small horsepower engines and electric motors to optimize torque and speed control for what would otherwise normally be high horsepower drives, the invention typically uses a 50 hp motor/engine when known drives would use 250 hp motors/engines. Thus, the invention cuts costs and improves the operating efficiency, the larger engine being much more expensive than a smaller engine, and because with a smaller engine, the whole drive chain can be dimensioned for the smaller load. It is important to note that the hydraulic drive used in the invention is dimensioned for the larger engine (typically 250 hp), since the hydraulic system according to the invention can produce the same torque output as the large engine alternative, albeit at a reduced shredder shaft speed. The production rate of the hydraulic system according to the invention may thus be lower compared to known hydraulic systems of similar output capacity and use, but which are equipped with higher power prime movers.

The invention produces constant and maximum horsepower control by a variable displacement hydraulic pump which has torque control to reduce pump flow output as a function of pressure as maximum input horsepower is reached. Therefore once the maximum input horsepower is attained, and the operating pressure within the circuit increases, the flow of oil decreases at a ratio until a maximum horsepower is achieved, not allowing the engine or electric motor to exceed its capacity, yet producing an optimized flow as a function of pressure.

This occurs internally within the hydraulic pump circuit by monitoring the system operating pressure produced by the feedstock material being processed, sending this signal through a torque control valve spool with the hydraulic pump, and adjusting the hydraulic pump swash plate to vary the output flow of the hydraulic pump.

Further features of the invention will be described or will become apparent in the course of the following detailed description.

### BRIEF DESCRIPTION OF THE DRAWINGS

In order that the invention may be more clearly understood, the preferred embodiment thereof will now be described in detail by way of example, with reference to the accompanying drawings, in which:

FIG. 1 is a hydraulic diagram of a hydraulic drive system according to one embodiment of the invention, using an electric motor as prime mover;

FIG. 2 is a hydraulic diagram of a hydraulic drive system according to an alternative embodiment of the invention, using an internal combustion engine as prime mover;

FIG. 3 is a schematic showing the generated output horsepower as a function of the motor/engine speed;

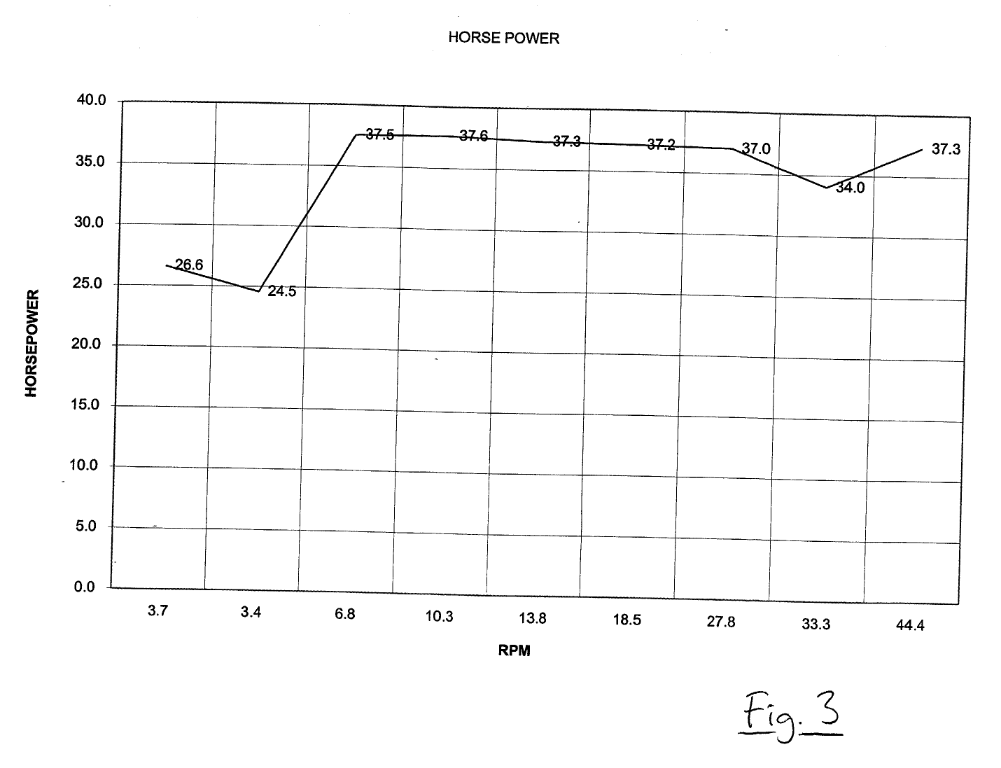

FIG. 4 is schematic showing the generated torque as a function of the variable shaft rotation speed; and

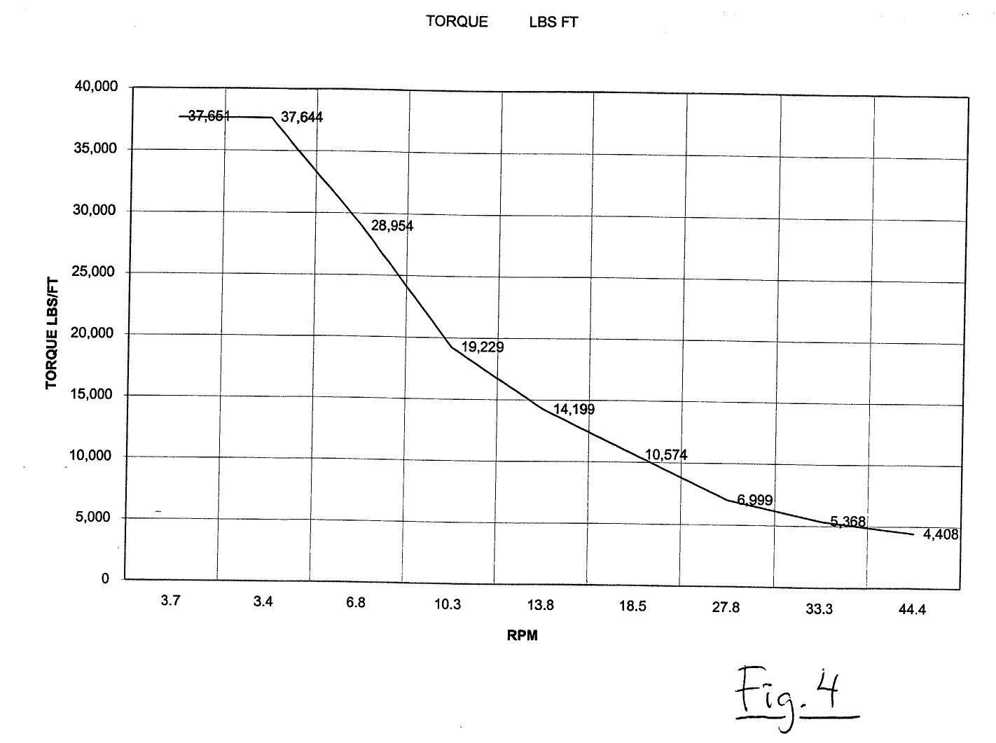

FIG. 5 is a schematic showing the generated knife force (cutter tip) as a function of the actual variable shaft rotation speed.

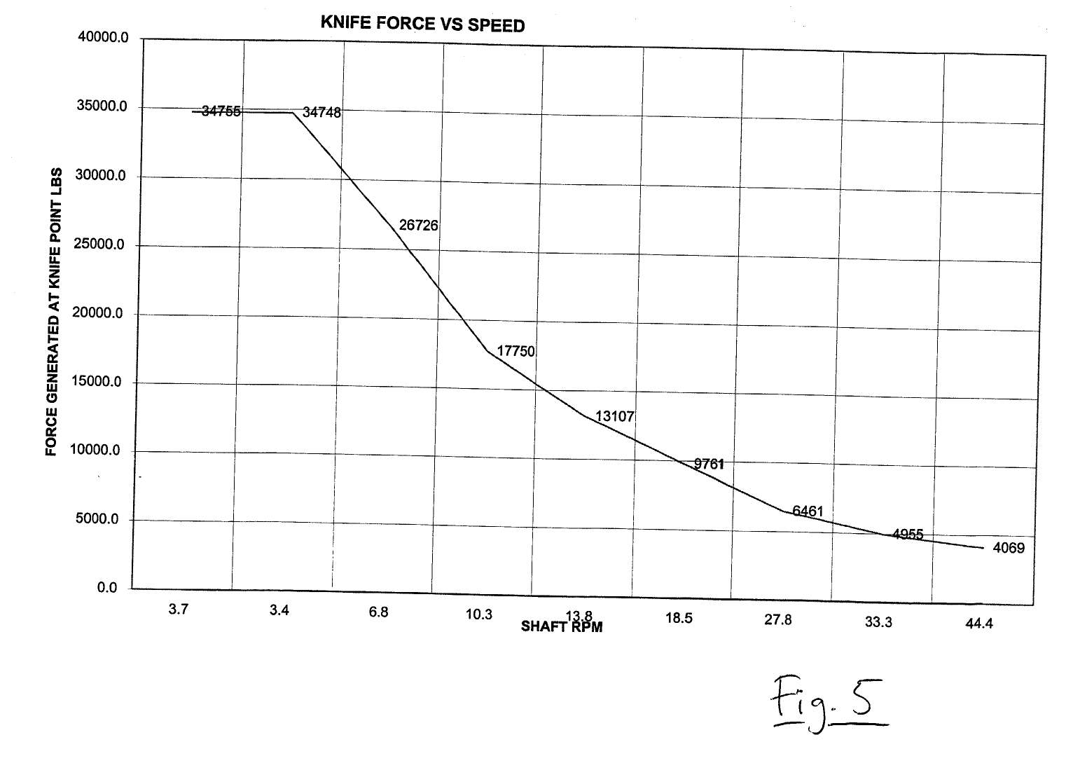

### DETAILED DESCRIPTION OF THE PREFERRED EMBODIMENT

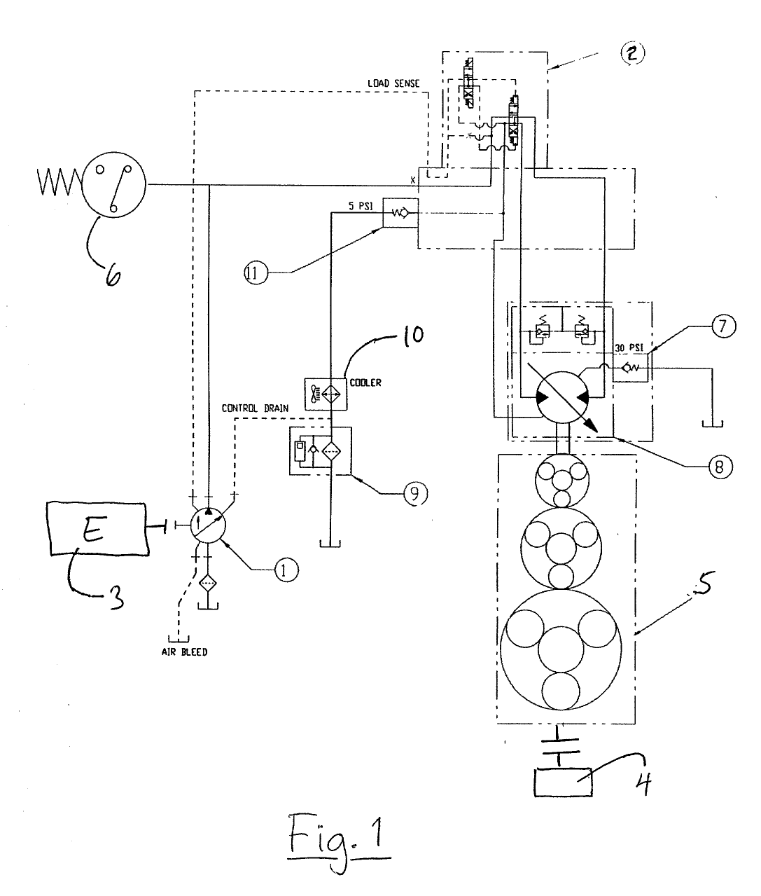

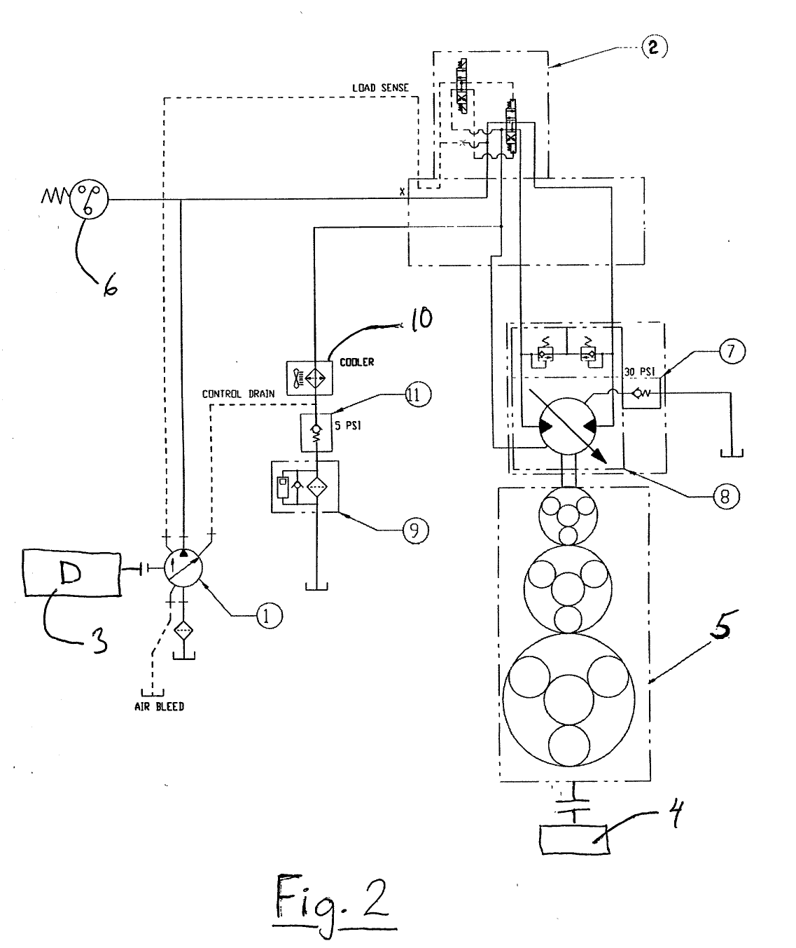

Referring to FIGS. 1 to 2, a hydraulic drive system according to one embodiment of the invention has a prime mover 3, an electric engine E in FIG. 1 and a diesel engine D in FIG. 2. The prime mover drives a hydraulic pump 1, which has a variable displacement. A control means within the pump, i.e. an integral part of the pump, for example a PLC, regulates the hydraulic pump displacement. Further, a hydraulic motor 8 is fed pressurized hydraulic fluid from the hydraulic pump via a valve means 2. The valve means is a directional valve assembly, to selectively provide three different fluid flow states to the hydraulic motor: flow for rotating a motor shaft in one direction, flow for rotating the motor shaft in the opposite direction and no flow (the motor shaft is not rotating). An optional reduction gear means 5, for example a planetary gear box as shown, connects the hydraulic motor with the shaft 4 to be rotated. A pressure switch 6 senses over pressure in the system, when the shaft is blocked from rotation, and sends a signal to the PLC. If this condition occurs a pre-set number of times within a pre-set time period (for example one minute), the prime mover is shut down and an operator alarm is generated.

Further parts of the hydraulic drive system are standard features, such as a filter 9, a cooler 10 and check valve 11. An over pressure valve 7 is advantageously attached to the hydraulic motor 8, to provide oil backpressure to lubricate the hydraulic motor

The calculation for fluid power is HP=(PSI×GPM)/1714.

In one embodiment of the invention, a continuously variable torque shaft drive is used which has a variable displacement hydraulic motor connected through planetary reduction and directly to a shredder shaft having at least one cutter attached. Other shafts to be rotated are included in the invention, for example multiple shafts independently or mechanically linked together through a gear mechanism. A displacement control spool (not shown) within the hydraulic motor 8 adjusts the movable motor swash plate (not shown) angle within a motor housing (not shown) to increase or decrease motor displacement as a function of the system operating pressure. This is produced by the hydraulic fluid system operating pressure produced by the cutter tip resistance for the feedstock material being processed by the shredder (FIG. 1). The motor initially works at minimum displacement up to a preset pressure (2000 psi as an example) which produces the motor's maximum speed and minimum torque. As the preset threshold is reached the motor's displacement control spool begins to adjust the motor swash plate angle, steplessly increasing the displacement of the motor. When the motor displacement is increased, the output torque increases and the output speed decreases, thus allowing the cutters to bear down on the feedstock material. The motor displacement is continuously variable to a maximum displacement at a preset pressure, at which time it will continually be adjusted to maximum displacement producing maximum torque and minimum output speed.

The pump and motor work together as a system to optimize performance for the feedstock material being processed, i.e. the power output requirements to the rotating shaft 4. For a shredder, the material is fed into a hopper, the cutter teeth penetrate into the material and are met with resistance. This resistance translates into a hydraulic fluid system operating pressure, feeding a signal back to both the pump horsepower control spool and the motor displacement control spool within the hydraulic motor. As the resistance of the cutter increases, the operating pressure increases, which causes the pump torque control to reduce the pump displacement and limit the pump input horsepower, while at the same time the hydraulic motor displacement is increased, reducing the shaft speed and increasing the torque output of the motor and thus increasing the cutter tip force. This happens continuously and steplessly throughout the processing cycle of the shredder.

If the cutter contacts an item that is unshreddable, the pump develops maximum hydraulic fluid system pressure at minimum displacement, the hydraulic motor is adjusted to maximum displacement (thus torque) and the hydraulic fluid system operating pressure activates a pressure reversing switch and sends this electrical signal through to the PLC. If this signal is held for a specified interval, for example one second, the PLC sends a signal to the hydraulic valve to reverse the direction of the oil flow to the hydraulic motor. This reverses the shaft direction of rotation for processing in the other direction. If this pressure reversing occurs for a preset number of times within a programmed time period, the PLC will detect this and send a signal to the prime mover to shut down and shut the shredder off.

A further feature of one embodiment of the invention is a timed auto reversing cycle, allowing the PLC to activate the hydraulic valve for direction change automatically as a function of time (a change of rotation direction after a pre-set time interval). This improves agitation of material within the hopper.

It will be appreciated that the above description relates to the preferred embodiment by way of example only. Many variations on the invention will be obvious to those knowledgeable in the field, and such obvious variations are within the scope of the invention as described and claimed, whether or not expressly described. For example, multiple shafts can be driven independently or through a mechanical linkage (gears etc.). Both slow speed and high speed processing equipment can be driven by a drive according to the invention.

What is claimed as the invention is:

1. A hydraulic drive system comprising:
a variable displacement hydraulic pump;
a prime mover operatively connected to said hydraulic pump;
a variable displacement hydraulic motor, operatively connected to said hydraulic pump, for driving a shaft;
wherein the torque and speed output of said hydraulic drive system is controlled by monitoring hydraulic fluid operating pressure in the system and adjusting the displacement of said hydraulic motor to adjust the speed output of said hydraulic motor, and adjusting the displacement of said hydraulic pump to vary the output flow of said hydraulic pump.

2. The hydraulic drive system as recited in claim 1, further comprising:
a system hydraulic fluid operating pressure sensor connected to said hydraulic pump,
a motor displacement control means connected to said hydraulic motor for a changing displacement of said motor, and
a pump displacement control means connected to said hydraulic pump for changing displacement of said pump;
wherein, at a preset hydraulic fluid operating pressure, said system hydraulic fluid operating pressure sensor activates said motor displacement control means and said pump displacement control means by a preset amount.

3. The hydraulic drive system as recited in claim 2, wherein said motor displacement means comprises:
a movable plate in said hydraulic motor, and
a drive means for moving said plate to a predetermined angle thereby altering the displacement of said hydraulic motor.

4. The hydraulic drive system as recited in claim 2, wherein said pump displacement means comprises:
a movable plate in said hydraulic pump, and
a drive means for moving said plate to a predetermined angle thereby altering the displacement of said hydraulic pump.

5. The hydraulic drive system as recited in claim 1, further comprising:
a directional valve means connected to said hydraulic pump and said hydraulic motor;
wherein said directional valve means alternates hydraulic fluid flow from said hydraulic pump to said hydraulic motor for causing said shaft to reversibly rotate or cease rotation in response to preset operating pressures.

6. The hydraulic drive system as recited in claim 1, wherein said prime mover is an electric motor.

7. The hydraulic drive system as recited in claim 1, wherein said prime mover is an internal combustion engine.

8. The hydraulic drive system as recited in claim 7, wherein said prime mover is a diesel engine.

9. The hydraulic drive system as recited in claim 1, wherein said system is an open loop hydraulic system.

10. The hydraulic drive system as recited in claim 1, wherein said system is a closed loop hydraulic system.

11. The hydraulic drive system as recited in claim 1, wherein said prime mover has a power rating substantially lower than a power rating of said hydraulic pump and said hydraulic motor.
